(19) United States
(12) Patent Application Publication
(10) Pub. No.: US 2012/0252625 A1
(43) Pub. Date: Oct. 4, 2012

(54) LIMITED SLIP DIFFERENTIAL HAVING A DYNAMIC THRUST DEVICE

(76) Inventor: Dominique Crasset, La Cour Marigny (FR)

(21) Appl. No.: 13/509,925

(22) PCT Filed: Nov. 15, 2010
(86) PCT No.: PCT/FR2010/000763

§ 371 Date: Jun. 11, 2012

(30) Foreign Application Priority Data
Nov. 16, 2009 (FR) 09/05497

(51) Int. Cl. F16H 48/22; F16H 48/20

(52) U.S. Cl. 475/231

(57) ABSTRACT

A limited slip differential comprising an input member and two output members and moreover having, built into a housing, at least one planet gear and at least one sun gear that are arranged so as to enable total or partial securing, rotatably, of two of the three input and/or output members by means of at least one thrust means on a securing means during a decrease in one of the output torques caused by grip loss or shifting into differential velocities. The differential also includes at least one second dynamic thrust means that is antagonistic to the thrust of the first thrust means, the antagonistic second dynamic thrust means being arranged so as to be activated during a shift of the differential into differential velocities.

The present invention relates to the field of self-locking or limited slip differentials allowing functioning in the event of grip loss of one of the output shafts, and more particularly to the field of limited slip differentials integrating a dynamic thrust device.

Differentials are mechanical systems comprising an input member and at least two output members whose function is to ensure distribution of rotation speed by distributing kinematic forces and rotation speeds in immediate and automatic manner, adapted to the needs of a mechanical assembly. One of the most common examples of use concerns motor vehicles for which the differential allows the drive wheels to rotate at different speeds when taking a corner. The wheels which lie on the outside of the bend are led to rotating faster than those lying inside the bend. This difference in rotation between the two output members or at least one output member with the input member is called the differential velocity since the speeds of rotation of the different members of the differential are different.

However, one of the main weaknesses of differentials is the loss of drive energy originating from the input when one of the wheels mounted on an output loses grip. This weakness was able to be offset through the development of self-locking or limited slip differentials, arranged to allow the detection of a difference in torque between the two output shafts and to limit the action of the differential in cases of insufficient grip on one of these two output shafts.

One example of a limited slip differential is taught in the publication of application FR 2638500. In this type of differential, a decrease in rotational torque of one output member relative to the counterpart output member or relative to the torque of the input ring gear of the differential leads to gradual securing via a clutch of the output shafts with the input ring gear of the differential.

However while said device allows the main known weakness of differentials to be overcome, it brings to light a new problem. A differential is a mechanical system involving friction and on this account comprises energy losses. For a motor vehicle differential which functions when driving round a bend, the drive wheel lying on the outside rotating faster undergoes greater energy loss on account of internal friction inside the differentials. This loss of energy then translates as a loss of drive torque transmitted to the rotating axle which carries this wheel at the output of the differential, notably on account of an axial rotation speed imposed by ground resistance on the wheel, and then leads to loss of drive torque on the outside wheel. In addition, this decrease in an output torque of the differential is recognized by the limited slip mechanism which reacts by securing together the output shafts triggering a so-called understeer phenomenon by altering the trajectory on a bend. It then becomes obvious that the use of a said limited slip differential can lead to imposing a trajectory on the driver of the vehicle, causing steering differences when taking a corner which may prove to be particularly dangerous for the driver and surroundings.

The object of the present invention is to overcome one or more disadvantages of the prior art and in particular to propose a novel differential with which it is possible to overcome at least in part the problem of vehicle control when driving round a bend.

This objective is reached by means of a limited slip differential comprising firstly an input member and two output members and secondly integrating in a housing at least one sun gear and at least one planet gear arranged to allow the full or partial securing in rotation of two of the three input and/or output members through the action of at least one first thrust means on securing means at the time of a decrease in one of the output torques caused by grip loss or shifting into differential velocities, characterized in that the differential also comprises at least one second dynamic thrust means antagonistic to the action of the first thrust means, the second antagonistic dynamic thrust means being arranged so that it can be actuated when the differential is shifted into differential velocities.

According to one particular aspect of embodiment, the limited slip differential is characterized in that the first thrust means acts on the axial force of the input member,

According to another particular aspect of embodiment, the limited slip differential of the invention is characterized in that the differential comprises an arrangement which, at the time of shifting of the differential into differential velocities, generates at least one friction specific to this shifting used to actuate a second antagonistic dynamic thrust means.

According to another particular aspect of embodiment, the limited slip differential of the invention is characterized in that the second antagonistic dynamic thrust means forms a connection with the output member having a differential velocity and at least one of the other members of the differential via at least one ramp for applying an antagonistic dynamic force generated by the friction occurring at the time of shifting of the differential into differential velocities.

According to another particular aspect of embodiment, the limited slip differential of the invention is characterized in that the second antagonistic dynamic thrust means is formed by an element mounted mobile in rotation relative to a planet gear of the differential and/or a hub which connects the planet gear with an output shaft of the differential, this mobile element—by means of a ramp fixed in rotation—meshing with the planet gear and/or hub of the differential.

According to a specificity of this particular aspect of embodiment, the limited slip differential of the invention is characterized in that the second antagonistic dynamic thrust means comprises at least one articulating point bearing against a ramp of a hub of the differential.

According to one detail of this specificity, the limited slip differential of the invention is characterized in that the articulating point makes use of a lug.

According to another specificity of this particular aspect, the limited slip differential of the invention is characterized in that the second antagonistic dynamic thrust means comprises at least one articulating point bearing against a ramp of a planet gear of the differential.

According to another specificity of this particular aspect, the limited slip differential of the invention is characterized in that the second antagonistic dynamic thrust means comprises at least one articulating point bearing against a ramp of an element mounted fixed in rotation with a planet gear and/or a hub of the differential.

According to one particular aspect of embodiment, the limited slip differential of the invention is characterized in that the planet gear drives in rotation the hub mounted mobile in translation relative to the planet gear, the hub comprising at least a third antagonistic thrust means formed by at least one pair of ramps arranged in a V-shape so that the junction of the ramps forms a point oriented in the direction of the planet gear to cooperate with the ramps of the planet gear.

According to one other particular aspect of embodiment, the limited slip differential of the invention is characterized in that the sun gear drives in rotation the planet gear mounted mobile in translation relative to the rotation shaft of the sun gear, the rotation shaft of the sun gear being fixed in rotation with the input member, the planet gear comprising at least one third antagonists thrust means formed by at least one pair of ramps arranged in a V shape so that the junction of the ramps forms a point oriented in the direction of the sun gear to cooperate with the ramps of the sun gear;

According to another particular aspect of embodiment, the limited slip differential of the invention is characterized in that the second antagonistic dynamic thrust means is formed by a ring centered on the rotation shaft of an output of the differential, this ring being positioned so that it is able to transfer a force axially along a housing separating the case of the differential and the hub of the output shaft, so that it bears via a first end against the side of a member of the differential oriented towards the output of the differential.

According to another particular aspect of embodiment, the limited slip differential of the invention is characterized in that the second antagonistic dynamic thrust means is arranged so that its rotation is limited by means of a lug intended to be in contact with at least one limiter that is fixed in rotation with a planet gear and/or a hub of the differential.

According to another particular aspect of embodiment, the limited slip differential of the invention is characterized in that the differential comprises at least one friction connection able to be placed under pressure by an axial force of the input member in a direction opposite the direction of thrust of the second antagonistic dynamic thrust means, the friction connection comprising at least one disc mounted fixedly in rotation with the second antagonistic dynamic thrust means.

According to another particular aspect of embodiment, the limited slip differential of the invention is characterized in that the differential comprises at least one friction connection able to be placed under pressure by an axial force of the second antagonistic dynamic thrust means under the action of a ramp.

According to another particular aspect of embodiment, the limited slip differential of the invention is characterized in that part of the second antagonistic dynamic thrust means comprises at least one friction connection able to be placed under pressure by an axial force of the hub in an opposite direction to the direction of thrust of the second antagonistic dynamic thrust means, so that the decrease in the output torque of the differential leads to an increased in the pressure of the first thrust means against the planet gear and/or the hub.

According to a specificity of this particular aspect of embodiment, the limited slip differential of the invention is characterized in that the friction connections being positioned in an arrangement of the case, these connections are formed by an alternate arrangement of discs respectively fixed to part of the first thrust means and to part of the case of the differential.

According to another specificity of this particular aspect of embodiment, the limited slip differential of the invention is characterized in that the friction connections being positioned in an arrangement of the case, these friction connections comprise at least one disc mounted fixedly in rotation to part of the case via a freewheel.

According to another particular aspect of embodiment, the limited slip differential of the invention is characterized in that the second antagonistic dynamic thrust means is formed by an element centered on the rotation shaft of an output of the differential, these second antagonistic dynamic thrust means comprising at least one ramp to combine rotation of the antagonistic dynamic thrust means with the axial producing of an antagonistic force at one face bearing against an element of the differential fixed in rotation with the input member.

According to one alternative embodiment, the limited slip differential of the invention is characterized in that the second antagonistic dynamic thrust means is drive in rotation by friction by a planet gear and/or an element fixed in rotation with a planet gear at one of the faces thereof, around a shaft parallel to the rotation shaft of the output member, so that rotation of the second antagonistic dynamic thrust means relative to the input member generates axial translation of the second antagonistic dynamic thrust means which increases the pressure force of the second antagonistic dynamic thrust means on the planet gear.

According to one specificity of this alternative embodiment, the limited slip differential of the invention is characterized in that the second antagonistic dynamic thrust means is mounted in rotation on a guide shaft, the guide shaft being firstly perpendicular to the plane of the rotation shafts of the sun gears, and secondly free in rotation relative to the differential and the guide shaft comprising at least one screw thread arranged to interact with the second antagonistic dynamic thrust means so as to produce a combined movement of rotation of the second antagonistic dynamic thrust means with axial translation of these second thrust means.

According to another alternative embodiment the limited slip differential of the invention is characterized in that the second antagonistic dynamic thrust means are driven in rotation at one inner face opposite the rotation shaft of a planet gear, by friction with a planet gear and/or an element mounted fixedly in rotation with a planet gear, one peripheral end of the second thrust means comprising a ramp which interacts with traction means secured to a pressure ring plate mounted free in translation in the case of the differential so as to generate a dynamic force antagonistic to the force or movement of the pressure ring plate at the time of shifting of the differential into differential velocities.

According to one specificity of this alternative embodiment, the limited slip differential of the invention is characterized in that the planet gear and/or the element fixed in rotation with the planet gear is mounted mobile in axial translation relative to the shaft of at least one sun gear of the differential, under the action of at least one third antagonistic thrust means formed by ramps.

According to another alternative embodiment, the limited slip differential of the invention is characterized in that the second antagonistic dynamic thrust means are mounted free in rotation relative to a sun gear on a shaft common with the sun gear so as to be driven by friction by the sun gear, the second antagonistic dynamic thrust means being arranged so that rotation thereof at the time of shifting of the differential into differential velocities, interacts with traction means mounted fixed in translation with a pressure ring plate so as to generate a dynamic force antagonistic to the force or movement of the pressure plate at the time of shifting of the differential into differential velocities.

According to one specificity of this alternative embodiment, the limited slip differential of the invention is characterized in that the second antagonistic dynamic thrust means comprise at least one cut-out in which part of the traction means is caused to slide so as to translate along an axis parallel to the axis of the output members at the time of rotation of the second antagonistic dynamic thrust means.

According to another specificity of this alternative embodiment, the limited slip differential of the invention is characterized in that the second antagonistic dynamic thrust means comprise at least one cut-out whose end forms an abutment bearing against a part of at least one traction means so as to bring the traction means in translation along an axis parallel to the axis of the output members at the time of rotation of the dynamic thrust means.

According to one particular aspect of embodiment, the limited slip differential of the invention is characterized in that the driving in differential rotation of an idle-mounted mobile element by the second dynamic thrust means causes an axial force antagonistic to the force of the thrust means of the output opposite the differential, the idle-mounted mobile element undergoing friction torque with an element of the differential when it is driven in differential rotation.

According to a specificity of this particular aspect of embodiment, the limited slip differential of the invention is characterized in that the hub and/or mobile element moves with the second dynamic thrust means by means of respective ramps.

The invention with its characteristics and advantages will become more clearly apparent on reading the description given with reference to the appended drawings in which:

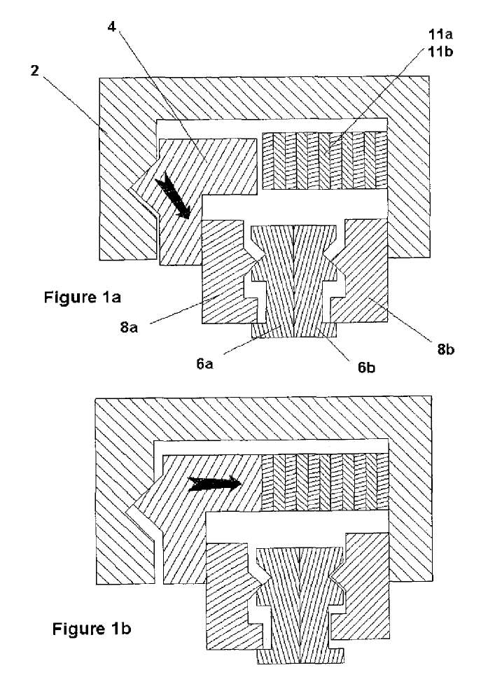

FIGS. 1a and 1b schematically illustrate the functioning of a limited slip differential according to the prior art;

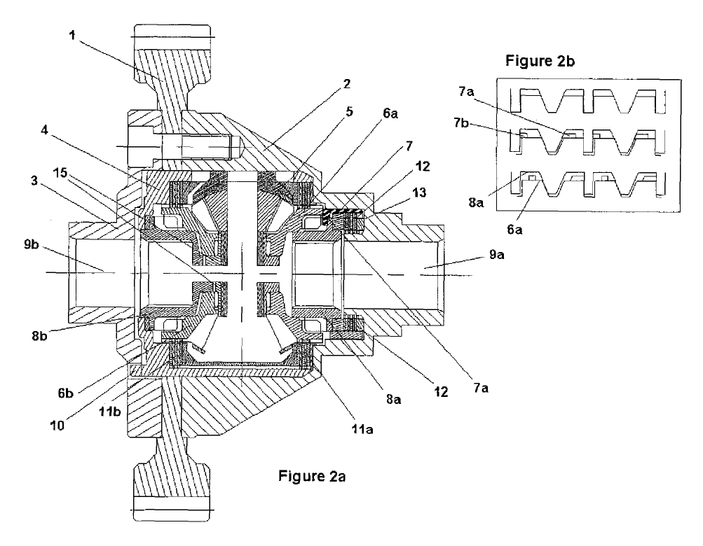

FIG. 2a illustrates a section of a first particular embodiment of the invention along a plane of symmetry integrating the rotation axis of the outputs of the differential, FIG. 2b illustrates the interaction occurring between the second thrust means with a planet gear and its hub;

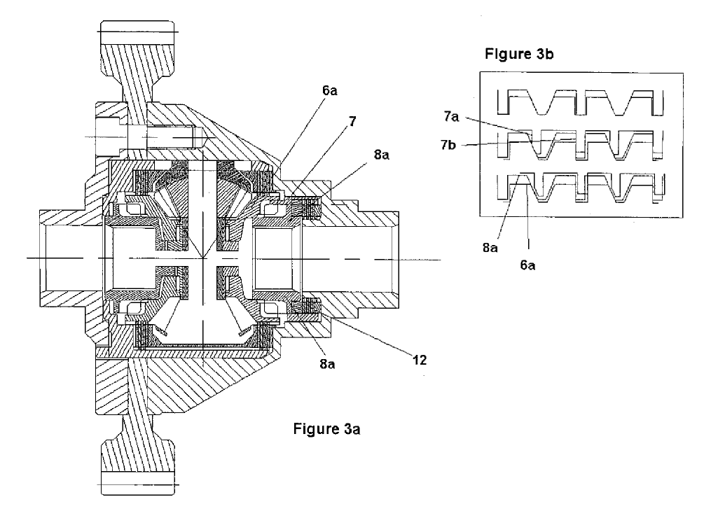

FIG. 3a illustrates a section of a variant of the first particular embodiment of the invention along a plane of symmetry integrating the rotation axis of the outputs of the differential, FIG. 3b illustrates the interaction occurring between the second thrust means and a planet gear,

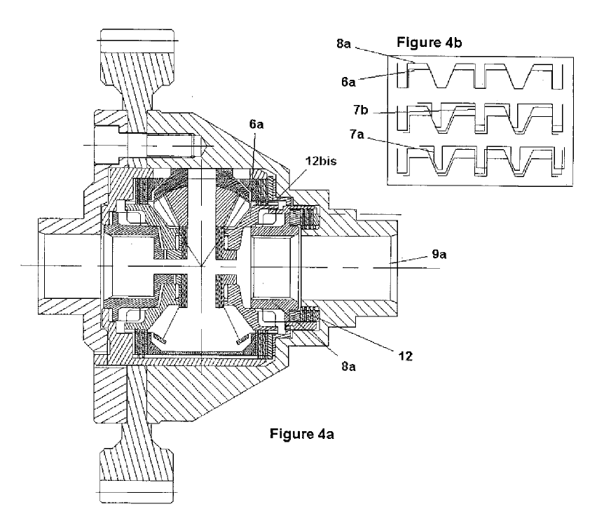

FIG. 4a illustrates a section of a variant of the first particular embodiment of the invention along a plane of symmetry integrating the rotation axis of the outputs of the differential, FIG. 4b illustrates the interaction occurring between the second thrust means and an additional friction connection,

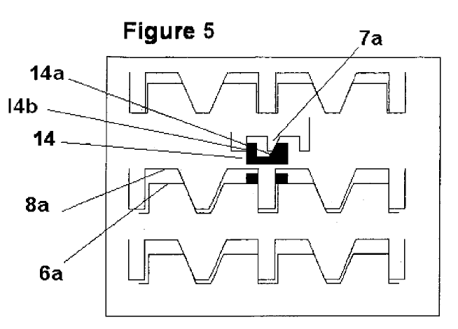

FIG. 5 illustrates the interaction occurring between the second thrust means and an additional intermediate part mounted on a planet gear,

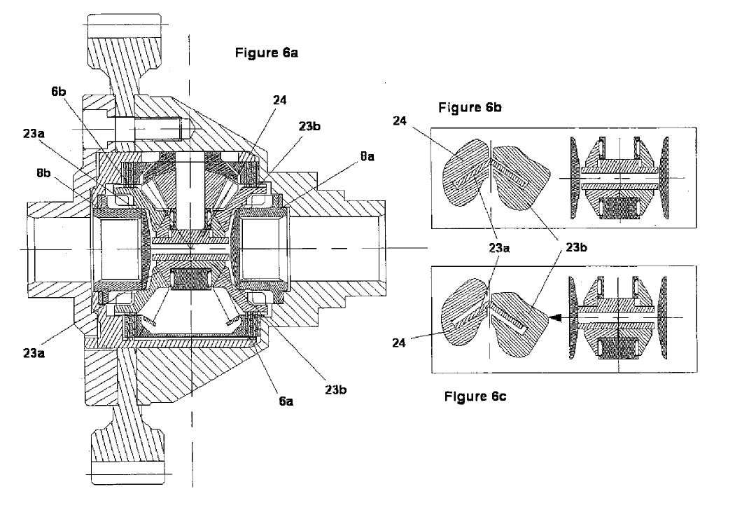

FIG. 6a illustrates a section of a second particular embodiment of the invention along a plane of symmetry integrating the axis of rotation of the outputs of the differential, FIGS. 6b and 6c illustrate the interaction taking place between the second thrust means with the guide shaft imposing translation thereupon;

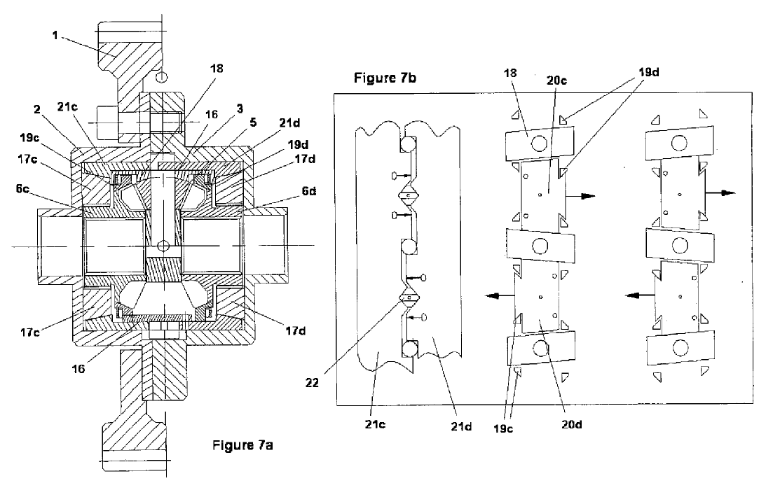

FIG. 7a illustrates a section of a third particular embodiment of the invention along a plane of symmetry integrating the axis of rotation of the outputs of the differential, FIG. 7b illustrates the interaction occurring between the second thrust means with the traction means of pressure plates of the differential;

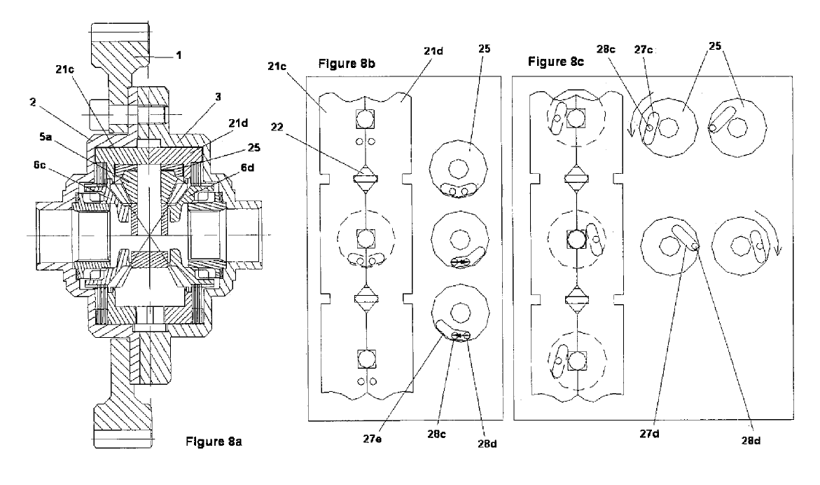

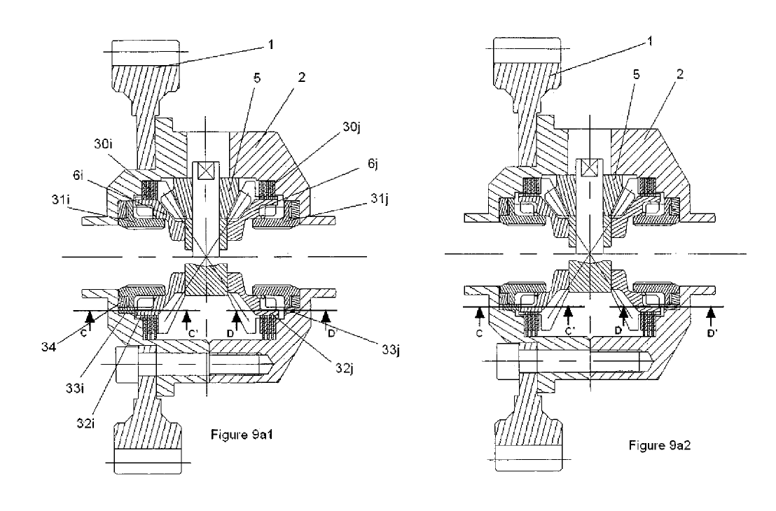

FIG. 8a illustrates a section of a fourth particular embodiment of the invention along a plane of symmetry integrating the axis of rotation of the outputs of the differential, FIG. 8b illustrates the interaction taking place between the second thrust means and the pressure plates of the differential according to a first variant, and FIG. 8c shows the interaction taking place between the second thrust means and the pressure plates of the differential according to a second variant;

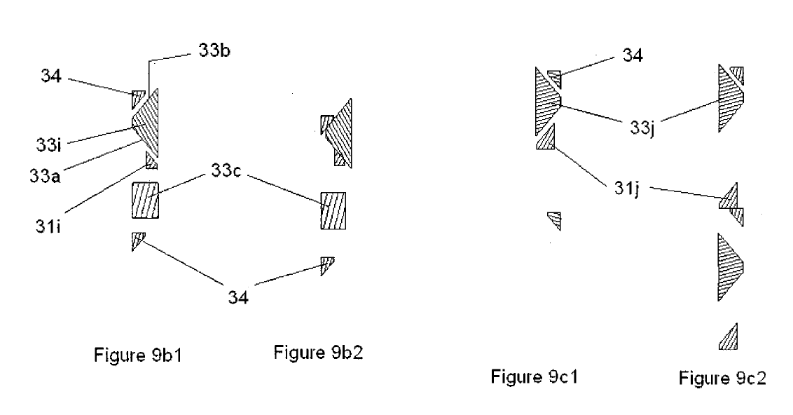

FIGS. 9a1 and 9a2 respectively illustrate a section of fifth particular embodiment of the invention along a plane of symmetry integrating the axis of rotation of the outputs of the differential when functioning with loss of resisting torque on an output, referenced i in FIG. 9a1, and when functioning at differential velocities of the device in FIG. 9a2;

FIGS. 9b1 and 9b2 respectively illustrate a section of the embodiment of the device of the invention along a plane passing through the axis C-C′ in the situations illustrated in FIG. 9a1 and FIG. 9a2;

FIGS. 9c1 and 9c2 respectively illustrate a section of the embodiment of the device of the invention along a plane passing through the axis D-D′ in the situation illustrated in FIG. 9a1 and FIG. 9a2.

It is to be noted that for reasons of clarity, the figures and explanations are given showing clearance and displacement between the different parts. This clearance and some of these displacements do not in fact exist during the functioning of the invention, the parts do not move relative to each other but all remain in contact with one another. These displacements are shown to illustrate variations in forces that are modified, transmitted or moved through these parts.

The device of the invention concerns a differential formed of an input member provided with a ring gear (1) receiving the torque and rotational movement originating from the engine, and at least two outputs (9a, 9b) at which at least one shaft is driven in rotation. According to one particular embodiment to which consideration is given in the remainder of the present description but does not limit the invention, the output shafts (9a, 9b) are aligned. The ring gear (1) of the differential is mounted fixedly with a case (2) and a cover (3) in which a disc carrier (4) is arranged. This disc carrier (4) is in the form of a cylinder mounted fixedly in rotation with the case (2) but able to slide in translation along the axis of the outputs ((9a, 9b)) of the differential. The disc carrier (4) also interacts at one end with the cover (3) of the differential. This differential also comprises at least one sun gear (5) arranged to pivot about a rotation shaft mounted fixedly with the disc carrier (4) and the case (2). Associated with at least one sun gear (5) of the differential there is also at least one planet gear (6a, 6b) which notably transmits rotational energy to an output (9a, 9b) of the differential.

By way of indication, although the example described in the present document conventionally concerns a free or open differential, this example is non-limiting and the device of the invention can easily be adapted onto an epicyloid differential such as proposed for example in the publication FR 2638500.

According to one first particular embodiment, the transmission of rotation energy from the planet gear (6a, 6b) to the rotation shaft of the output (9a, 9b) takes place via a hub (8a, 8b) mounted in rotation about an axis common to the planet gear (6a, 6b) and to the output shaft (9a, 9b). This hub (8a, 8b) is mounted fixedly with the rotation shaft of the output (9a, 9b) and engages with the planet gear (6a, 6b) by means of an antagonistic thrust means formed by a particular arrangement of mechanical cooperation schematically illustrated in FIG. 1 between these two parts. These antagonistic thrust means form a third thrust means in the differential of the invention.

The assembly formed by the different parts of the differential arranged in the volume formed by the disc carrier (4) and the case (2) is held under pressure along an axis substantially parallel to the axis of the outputs ((9a, 9b)) of the differential, This placing under pressure is ensured in particular and maintained by a first thrust means i.e. ramps (10) at the end of the disc carrier (4) which interact with the cover (3), the disc carrier (4) being able to slide in the case (2) to maintain this pressure by joining up with the bottom of the case (2). Each of the ends of the disc carrier (4) comprises clutches (11a, 11b) formed of a plurality of discs sliding in translation and fixed in rotation relative to the disc carrier (4) and arranged alternately with a plurality of discs fixed in rotation relative to the respective planet gear (6a, 6b) on which the latter slide in translation. The sliding of the disc carrier (4) in the case (2) increases when pressure is applied to the clutches (11a, 11b) and progressively with this sliding of the disc carrier (4) secures the rotation of the planet gears (6a, 6b) with the rotation of the disc carrier (4), of the case (2) and of the ring gear (1) of the differential.

The arrangement of mechanical cooperation between the hub (8a, 8b) and the planet gear (6a, 6b), which forms the third antagonistic thrust means, allows firstly the driving in rotation of the hub (8a, 8b) by the planet gear (6a, 6b) and secondly the drawing away of the hub (8a, 8b) and of the planet gear (6a, 6b) when the rotation shaft of the output (9a, 9b) has resisting torque. In one non-limiting example of embodiment, this cooperative arrangement is formed by a succession of ramps positioned on the periphery of the hub (8a, 8b) to engage with their counterparts arranged on the periphery of the planet gear (6a, 6b). Another arrangement can be formed by ramps belonging to one of the elements, hub or planet gear, and cooperating with at least one intermediate part secured to the other element, planet gear or hub respectively. According to one preferred embodiment, the ramps of the hub (8a) are arranged to have a “V” shape so that the junction of a pair of ramps forms a point oriented in the direction of the planet gear (6a). Therefore one ramp of the hub (8a, 8b) engages with a ramp of the planet gear (6a, 6b) so as to allow either a rotation or rotation combined with translation. This spacing between hubs (8a, 8b) and planet gears (6a, 6b) tends to oppose the axial pressure of the disc carrier (4) on the parts of the differential. When the torque of the rotation shaft of an output (9a, 9b) is decreased, the space between the hub (8a, 8b) and the planet gear (6a, 6b) is reduced owing to the axial pressure applied by the disc carrier (4) on the parts of the differential. The maintaining of the axial pressure of the differential is ensured by means of gradual sliding of the disc carrier (4) in the case (2) which simultaneously causes gradual securing of the planet gears (6a, 6b) with the rotation of the disc carrier (4), of the case (2) and of the ring gear (1) of the differential by compression of the clutches (11a, 11b).

The objective of the device of the invention is to generate an antagonistic force to sliding to allow the securing of the differential at the time of shifting of the differential into differential velocities, and optionally to offset the loss of speed imparted to an output shaft (9a, 9b) in positive rotation relative to the case (2) due to the loss of rotational speed of a planet gear (6a, 6b) subsequent to losses of energy due to mechanical friction of the third antagonistic thrust means of the differential. The rotational speed of the output shaft (9a, 9b) of the differential then comes to be faster than that of its corresponding planet gear (6a, 6b) and is detected by the limited slip differential as a reduction in the torque at the output shaft (9a, 9b).

The device of the invention is based on the use of a second dynamic thrust means arranged firstly to apply pressure antagonistic to the pressure provided by the first thrust means on the disc carrier (4) and on the elements of the differential, and to oppose the gradual sliding of the disc carrier (4) in the case (2) and hence the placing under pressure of the clutches (11a, 11b) and the securing in rotation of the planet gears (6a, 6b) with the disc carrier (4) and the case (2), and secondly if necessary to provide a dynamic force in addition to the existing antagonistic thrust means.

Preferably, the embodiment gives priority to a differential whose second antagonistic dynamic thrust means act in priority on the output shaft whose differential velocity is positive i.e. whose output shaft corresponds to the outer wheel on a curved trajectory.

According to one particular non-limiting embodiment of the principle of the invention, adapted to detect grip loss or shifting into differential velocities, this effect is obtained by the second antagonistic dynamic thrust means (7) that is annular and cylindrical centered on the rotation shaft of the output member (9a) concerned. These second antagonistic dynamic thrust means (7) are positioned in a housing (13) of the case (2) of the differential so that they are able firstly to perform axial rotation about the output member (9a) and secondly an axial translation along this same shaft.

The second antagonistic dynamic thrust means (7) according to the invention have a first face oriented against the case (2) and a second face oriented against the hub (8a) associated with the output member (9a). These second antagonistic dynamic thrust means (7) also have a first end outside their housing (13) which is able to bear against one of the elements of the differential, preferably against the planet gear (6a) which engages with the hub (8a). This bearing point of the second antagonistic dynamic thrust means (7) on the differential sets up a pressure producing a force antagonistic to the sliding of the disc carrier (4) in the casing (2).

According to one particular embodiment, the bearing point of the second antagonistic dynamic thrust means (7) on the differential against the planet gear (6a) is achieved via one or more lugs (7a) intended to be inserted against one or more ramps of the planet gear (6a) as illustrated in FIG. 3a. These lugs (7a) secured to the thrust means (7) are then driven in rotation by the ramps of the planet gear (6a) whilst generating axial displacement in the direction of sliding of the disc carrier (4). In addition, this positioning of the lug (7a) against a ramp allows additional rotation resistance to be generated by associating itself with the hub (8a) which opposes the rotational torque of the planet gear (6a).

According to another particular embodiment, at this end, the second antagonistic dynamic thrust means (7) comprise one or more lugs (7a) intended to be inserted between the planet gear (6a) and its hub (8a) as illustrated in FIG. 2a. These lugs (7a) are secured to the second antagonistic dynamic (7) thrust means and are arranged firstly to be driven in rotation either by the planet gear (6a) or its hub (8a) and secondly, due to the presence of ramps on the planet gear and the hub, to generate axial displacement in a direction antagonist to the direction of sliding of the disc carrier (4). In addition, the positioning of the lug (7a) against a ramp allows rotational resistance to be generated by being associated with the hub (8a) to oppose the rotation torque of the planet gear (6a).

According to one particular arrangement, the meshing between the hub (8a) and the planet gear (6a) is formed by an alternate succession of ramps and limiters positioned on the periphery of the hub (8a) to engage with their mating parts arranged on the periphery of the planet gear (6a). These limiters restrict firstly the rotation of the hub (8a) relative to the planet gear (6a) and secondly the rotation of the second antagonistic dynamic thrust means (7) by blocking the rotational clearance of at least one of its lugs (7a).

According to another particular embodiment, the end of the second antagonistic dynamic thrust means (7) comprises at least one articulating point formed by a lug (7a) bearing against a ramp of a particular part (14) forming an element mounted fixedly in rotation with a planet gear (6a) and/or a hub (8a) of the differential via one of its parts, and another part comprising a ramp (14a) against which there bears a lug (7a) of the second antagonistic dynamic thrust means (7). According to one particular configuration, the rotational clearance of the lug (7a) is restricted by the positioning of particular limiters (14b) on the part mounted fixedly with the planet gear and/or the hub. According to one alternative configuration, illustrated in FIG. 6, these particular limiters 7b are directly carried by the second antagonistic dynamic thrust means (7).

The second end of the second antagonistic dynamic thrust means (7) remains positioned in the housing (13). This end comprises a plurality of discs mobile in translation and centered on the same axis as the second antagonistic dynamic thrust means (7). These discs, fixed in rotation with the second antagonistic dynamic thrust means (7), are arranged alternately with a plurality of discs mobile in translation and mounted fixed in rotation relative to the case (2) of the differential, so as to form friction connections (12) allowing slowing of the axial rotation of the second antagonistic dynamic thrust means (7) when these friction connections (12) are placed under pressure.

The friction connections (12), formed by an alternate arrangement of discs, are positioned between the bottom of the housing (13) of the second antagonistic dynamic thrust means (7) in the case (2) and a surface of the hub (8a). This particular positioning means that when the hub (8a) moves away from the planet gear (6a) associated with it i.e. when the hub (8a) is driven in rotation by the planet gear (6a) and the rotation speed of the output shaft (9a) is identical to the that of the case (2), the hub (8a) bears on the friction connections (12) and causes slowing of the rotation of the second antagonistic dynamic thrust means (7). This slowing of the rotation of the second antagonistic dynamic thrust means (7) forms additional resistance to the rotational torque of the hub (8a) and of the output shaft and concomitantly causes slowing of the rotation of the hub (8a) simultaneously allowing the offsetting of losses of antagonistic axial forces due to losses of mechanical energy at the time of shifting into differential rotation in particular on the output shaft (9a) which has a positive rotation speed relative to the input member formed by the ring gear (1), the case (2) and the disc carrier (4).

According to one particular embodiment, the second antagonistic dynamic thrust means (7) comprise a friction connection (12bis) able to be placed under pressure by axial displacement of the input member in a direction opposite to the direction of thrust of the second antagonistic dynamic thrust means (7). This particular friction connection notably involves at least one ring (12bis) arranged to have a first planar peripheral surface which bears upon one end of the case (2) and a second fixed surface, in particular fixed in rotation with the second antagonistic dynamic thrust means (7). One end of the input member or of the disc carrier (4) which in particular comprises means for placing under pressure (15) intended to press on the first surface of the friction connection (12bis) to placed it under pressure. In this embodiment, the decrease in differential output torque causes displacement of the disc carrier (4) in the case (2) and simultaneously an increase in pressure of the pressuring means (15) against the surface of the friction connection (12bis) thereby slowing the rotation of the second antagonistic dynamic thrust means (7) and slowing the faster rotation of the hub (8a) relative to the planet gear (6a). The friction connection (12bis) in this embodiment can be operated alone or in combination with the friction connections (12) between the second antagonistic dynamic thrust means (7) and the case (1).

According to one specific embodiment, the friction connections (12) between the second antagonistic dynamic thrust means (7) and the case (2) are positioned so that the discs mounted with the case (2) are fixed via a freewheel (15) which connects the discs to the case (2). This freewheel (15) is preferably arranged so that its rotation is blocked when friction is due to positive rotation of the discs relative to the case (2), so that the discs are then fixed in rotation with the case (2). Conversely, when friction is due to negative rotation of the discs relative to the case (2), the action of the friction connections (12) or the loss of energy due to friction is reduced since the discs mounted on the case (2) are mobile in rotation relative to the case (2). This freewheel (15) therefore allows the imposed functioning of the system of the invention only when grip loss or shifting into positive differential velocity is detected at the output shaft (9a).

According to one particular embodiment, the friction connections (12, 12bis) of the device of the invention can use Belleville washers to ensure minimal and permanent axial pressure.

On the other hand, when the planet gear (6a) transmits engine torque to the hub (8a) via the third antagonistic thrust means, the result is an antagonistic force applied to the friction connections (12) which are able to set in operation the second antagonistic dynamic thrust means (7) when the device shifts into differential velocities.

It is to be noted that although this embodiment is only illustrated in FIG. 2a with a single differential output, this embodiment is applicable to both outputs.

One alternative embodiment of the invention can be obtained via second circular antagonistic dynamic thrust means (15) centered on the axis of rotation of the output member (9b) concerned. These second antagonistic dynamic thrust means (15) are positioned so as to be driven in rotation by the hub (8b), itself driven in rotation by the corresponding planet gear (6b). This driving is achieved by providing ramps in an arrangement symmetrical with the planet gear (6a)/hub (8a) arrangement previously described in relation to the plane of symmetry formed by the plane comprising the rotation shafts of the sun gears (5a, 5b). However, contrary to its symmetric equivalent, the hub (8b) is blocked in its axial displacement by abutments of the cover (3) against which the hub (8b) rotates via a needle bearing to avoid any friction. The second antagonistic dynamic thrust means (15) are set in rotation by the hub (8b) at a first face via driving which uses ramps so that the second antagonistic dynamic thrust means (15) receive an axial force when they are set in rotation. These second antagonistic dynamic thrust means (15) are also positioned between a part of the planet gear (5b) and an element fixed in rotation with the shafts of the sun gears (5a, 5b) of the differential so that these second antagonistic dynamic thrust means (15) remain fixed in translation with the planet gear (5b), the disc carrier (4) and the satellites (5a, 5b), and the axial force they receive when set in rotation leads to an increase in friction of the second antagonistic dynamic thrust means (15) at a second face bearing against a fixed element of the differential e.g. the shafts of the sun gears (5a 5b). According to one preferred embodiment, when the rotation of the second antagonistic dynamic thrust means (15) is ensured by the hub (8b) the friction which might exist between the second antagonistic dynamic thrust means (15) and the planet gear (6b) are eliminated via an adapted needle bearing.

At the time of shifting to a positive differential velocity at the output member (9b), the friction internal to the differential leads to losses of engine torque on this output shaft (9b). The second antagonistic dynamic thrust means (15) generate an antagonistic dynamic force dependent on the rotational friction of these second antagonistic dynamic thrust means (15). This increased friction leads concomitantly to slowing of the speed of rotation of the hub (8b) relative to the planet gear (6b) and hence, under the action of the ramps firstly between the hub (8b) and the planet gear (6b) and secondly between the hub (8b) and the second antagonistic dynamic thrust means, to the drawing away of these different parts which opposes the sliding of the disc carrier (4) in the case (1) under the action of its ramps (10).

It is to be pointed out that although this embodiment is only illustrated in FIG. 2a with a single differential output, this embodiment is applicable to both outputs.

According to one alternative embodiment, each of the hubs (8a, 8b) is integrated in its respective planet gear (6a, 6b). Each of the planet gears (8a, 8b) is therefore mounted mobile in axial translation relative to the input member, to the disc carrier (4) and to the sun gears (5a, 5b). The arrangement between the planet gears (6a, 6b) and the sun gears (5a, 5b) uses ramps similarly arranged to the driving mechanisms between the hubs (8a, 8b) and the planet gears (6a, 6b) previously described for the other embodiments. In this alternative embodiment, the force of sideway displacement initially lying between the planet gear (6a, 6b) and the hub (8a, 8b) is offset to between the sun gears (5a, 5b) and the planet gear (6a, 6b). The second antagonistic dynamic thrust means (7) then interact directly, via their end part, on the planet gear (6a).

In one variant of the invention forming a second particular embodiment, in which the general structure of the device, of the case and of the disc carriers is substantially similar to the structure of the variant forming the first particular embodiment, the second antagonistic dynamic thrust means (23a, 23b) of the slip differential are formed by a pair of elements (23a, 23b) mounted symmetrically relative to a plane of symmetry passing through the rotation shafts of the sun gears (5a, 5b) of the differential. The rotation shafts of the sun gears (5a, 5b) are half-shafts to allow the positioning of a guide shaft (24) of the second antagonistic dynamic thrust means which passes perpendicularly through the plane formed by the rotation shafts of the sun gears (5a, 5b). These second thrust means (23a, 23b) are mounted on their guide shaft (24) which passes through them. These second antagonistic dynamic thrust means (23a, 23b) are arranged so that they are able to operate free axial rotation relative to the sun gears (5a, 5b), to the disc carrier (4) and to the case (2). Each of these second antagonistic dynamic thrust means (23a, 23b) comprises a face in contact with a face of a respective planet gear (8a, 8b) so that the rotation of the planet gear (6a, 6b) causes the rotation via friction of the second antagonistic dynamic thrust means (23a, 23b) on their guide shaft (24). The guide shaft (24) comprises two screw threads (24a, 24b) respectively arranged symmetrically to one another either side of the plane of symmetry passing through the rotation shafts of the sun gears (5a, 5b) of the differential. Each of these screw threads (24a, 24b) is respectively arranged so that it mates with tapping in the bore of the rotation shaft of a respective second antagonistic dynamic thrust means (23a, 23b) so that the rotation of a second antagonistic dynamic thrust means (23a, 23b) relative to the guide shaft (24) causes axial translation of the second antagonistic dynamic thrust means (23a, 23b) against their respective planet gear (6a, 6b). In addition, to limit all parasitic friction, the second antagonistic dynamic thrust means (23a, 23b) engage with their other surrounding parts via needle bearings. Therefore, when the planet gears (6a, 6b) are in rotation with the input member, they drive in rotation via friction the second antagonistic dynamic thrust means (23a, 23b) with their guide shaft (24). When the device is in differential velocities, the hubs (8a, 8b) limited by the volume taken up by the case (1) and its cover (3) push their planet gears (6a, 6b) towards the plane of the rotation axes of the shafts of the sun gears (5a, 5b) increasing the friction of the planet gears (6a, 6b) against the second antagonistic dynamic thrust means (23a, 23b). On account of the clearance of the screw threads (24a, 24b) the differential rotation of the second antagonistic dynamic thrust means (23a, 23b) causes axial displacement of at least one of the second antagonistic dynamic thrust means (23a, 23b) drawing away these antagonistic dynamic means (23a, 23b) and hence generating a force complementary to the force of the ramps of the system which, when transmitted through the parts of the system, opposes the sliding of the disc carrier (4) in the case (2).

In one variant of embodiment of the invention forming a third particular embodiment, the slip differential comprises planet gears (6c, 6d) which form one same part with their respective hubs as illustrated in FIG. 7a. The differential according to this variant of embodiment comprises an input member (1) on which a cylindrical structure fixed in rotation is mounted, being fixed in rotation with the case (2) and the input member, inside which there are mounted one or more sun gears (5a, 5b) with which the planet gears (6c, 6d) are associated. This cylindrical structure (16) comprises a wall formed by an alternate arrangement of tabs (18) mounted fixed in rotation and in translation at and with shafts of the sun gears (5a, 5b) and oriented along the axis of the cylinder and of elements (20) fixed in rotation and mobile in translation with the shafts of the sun gears (5a,5b). These elements (20) fixed in rotation and mobile in translation are traction means (20) fixed in translation and rotation with a pressure ring (21c, 21d) which surrounds the cylindrical structure (16). These traction means (20) are alternately fixed onto one or other of the pressure rings (21c, 21d). The tabs (18) fixed in rotation and in translation are arranged to form ramps for the traction means (20) and to generate a force which opposes the drawing away of the pressure rings (21c, 21d). More details on these traction means (20) are explained below. This cylinder (16) is closed on either side by cones (17c, 17d) so that each of these cones (17c, 17d) is respectively mounted fixed in rotation with the planet gear (6c, 6d) located on the same side. Each of these cones (17c, 17d) is therefore respectively crossed by that part of a planet gear (6a, 6b) fixed to an output member. The slip differential according to this embodiment is formed along a plane of symmetry passing through the section of the cylinder (16) which comprises the rotation shafts of the sun gears (5a, 5b) of the differential, mounted fixedly with the case (2) of the differential. The cylinder (16) of the differential, on its peripheral surface, comprises two pressure rings (21c, 21d) mounted free in rotation and in translation relative to the cylinder (16) and arranged symmetrically so as to have a first edge oriented towards the plane of symmetry of the differential, and a second, free, edge which covers at least part of the periphery of the corresponding cone (17c, 17d) which takes part in the closing of the cylinder (16). On their edge oriented towards the symmetry of the differential, each of these pressure rings (21c, 21d) comprises a notch intended to engage with at least one part (22) positioned projecting in a housing of the case (2) in the plane of symmetry of the cylinder (16). This projection (22) forms first thrust means via a ramp on which the notch of the edge of each of the pressure rings (21c, 21d) imposes translation upon the pressure ring (21c, 21d) drawing it away from its plane of symmetry in the direction of its free edge when it is driven in rotation relative to the cylinder (16). This displacement of the pressure rings (21c, 21d) is dependent upon the engine torque applied by the case (2). The translation of the pressure rings (21c, 21d) and hence their rotation is slowed and then stopped however by the friction of the free edge of the pressure ring (21c, 21d) against the peripheral surface of the cone (17c, 17d) whose diameter widens relative to the diameter on the side of the cylinder (16). The peripheral surface of the cone (17c, 17d), by blocking the freedom of movement of the pressure ring (21c, 21d) relative to the remainder of the differential, thereby forms means for securing the output members together and with the input member. Also, when the planet gears (6c, 6d) of the differential are shifted to differential velocities, the cones (17c, 17d) are also set in rotation so that their friction, by opposing the rotation of the pressure ring (21c, 21d), generates an antagonistic thrust force to the displacement of the pressure rings(21c, 21d).

According to one particularity of this embodiment of the invention, the planet gears (6c, 6d) are arranged so that they are mobile in axial translation relative to the sun gears (5a, 5b) mounted fixed in rotation and in translation with the input member. The meshing between the planet gears (6a, 6b) and the sun gears (5a, 5b) uses teeth forming Vs and which act as ramps according to an arrangement similar to the driving mechanisms of the hubs (8a, 8b) by their planet gears (6a, 6b) in the previously described embodiments. During the balanced driving of the output members by the input member, the planet gears (6a, 6b) are repelled axially as far as a limit position so that one of their surfaces comes to bear against a surface of a respective second antagonistic dynamic thrust means (19c, 19d). When the planet gears are driven at differential velocity, one surface of each of the planet gears (6c, 6d) engages in rotation by friction with the lower face of respective thrust means (19c, 19d). These second antagonistic dynamic thrust means (19c, 19d) are mounted free in rotation relative to the cylinder (16) so as to slide in a groove formed between the edge of the cylinder (16) and a tab (18) bearing against the edge of a cone (17c, 17d) when it is driven by the friction of a planet gear (6c, 6d) in rotation. So as to restrict the friction of the second antagonistic dynamic thrust means (19c, 19d) with the cylinder (16), at least part of this friction can be eliminated through the use of needle bearings. This friction occurs when the planet gear (6c, 6d) draws away in translation from the plane of symmetry of the differentia, i.e. from the rotation shaft of the sun gears (5a, 5b). The rotation of the planet gears (6c, 6d) causes friction with the lower face of the second antagonistic dynamic thrust means (19c, 19d) which are then moved in rotation. One part of these second antagonistic dynamic thrust means (19c, 19d) comprises a ramp arranged to interact with a ramp carried by antagonistic traction means (20c, 20d) fixed in translation and in rotation with one of the pressure rings (21c, 21d) so that the movement of the ramp at the end of the second antagonistic dynamic thrust means (19) presses upon the ramp of the traction means (20) to generate a force which opposes the drawing away of the pressure ring (21c, 21d) from the plane of symmetry of the differential.

In one variant of embodiment of the invention forming a fourth particular embodiment illustrated in FIG. 8a, the slip differential comprises a structure substantially similar to the variant of embodiment of the invention forming the third particular embodiment. However, one (5a) of the sun gears is connected to the cylinder (16) via a disc-shaped intermediate part (25), coaxial in rotation with the sun gear (5a), which forms second antagonistic dynamic thrust means. These second antagonistic dynamic thrust means (25) have a first face in friction with the sun gear (5a) and a second face at which the friction with the cylinder (16) is limited and even non-existent by means of a bearing. These second antagonistic dynamic thrust means (25) are therefore freely mobile in rotation relative to the sun gear (5a) although driven in rotation by friction with this sun gear (5a). In symmetry, each of the pressure rings (21c, 21d) which surrounds the cylinder (16) comprises, close to the plane of symmetry which passes through the rotation shafts of the sun gears (5a, 5b) , a rod (28a, 28b) that has fixed movement with the pressure ring (21c, 21d).

According to a first particular aspect, each of the rods (28c, 28d) passes through an opening of the surface of the cylinder (16) to interact with a cut-out (27c, 27d) particular to it in a second antagonistic dynamic thrust means (25) particular to it. This cut-out (27c, 27d) of the second antagonistic dynamic thrust means (25) has an axial arrangement along a chord of the disc-shaped thrust means (25) so that pivoting of the second antagonistic dynamic thrust means (25) on its axis of rotation causes displacement of the rod (28c, 28d) and translation of the pressure ring (21c, 21d) to which it is fixed. Therefore, at the time of shifting into differential velocities of the device of the invention, the sun gear (5a) is set in rotation causing the rotation by friction of the second antagonistic dynamic thrust means (25). The pivoting of the second antagonistic dynamic thrust means (25), via the pivoting of its cut-out (27c, 27d) causes—via displacement of the rod (28c, 28d)—the translation of the pressure ring (21c, 21d) drawing it near to the plane of symmetry of the device, generating a dynamic thrust force antagonistic to the drawing away of the pressure rings (21c, 21d).

According to a second particular aspect, the rods (28c, 28d) pass through an opening in the surface of the cylinder (16) to interact with one same cut-out (27e) in the second antagonistic dynamic thrust means (25). This cut-out (27e) of the second antagonistic dynamic thrust means (25) has cross-section in the form of an arc of a circle with an abutment at each of its ends, so that pivoting of the second antagonistic dynamic thrust means (25) on its rotation axis generates a displacement of one of the rods (28c, 28d) driven by the abutment of the cut-out (27e) and the drawing together of the two rods and hence translation of the pressure ring (21c, 21d) to which it is fixed. Therefore, as in the first particular aspect of embodiment, at the time when the device of the invention is shifted into differential velocities, the sun gear (5a) is set in rotation driving by friction the rotation of the second antagonistic dynamic thrust means (25). The pivoting of the second antagonistic dynamic thrust means (25) by the pivoting of its cut-outs (27c, 27d) causes—via the displacement of one of the rods (28c, 28d)—the translation of the pressure ring (21c, 21d) by drawing near to the plane of symmetry of the device, generating a dynamic thrust force antagonistic to the drawing away of the pressure rings (21c, 21d).

In one variant of embodiment forming a fifth embodiment, the limited slip differential comprises a case (2) provided with a toothed ring gear (1). The case (2) also comprises at least one sun gear (5) and a planet gear (6i, 6j) associated with each output member. Each of these planet gears (6i, 6j) is associated with the case (2) of the differential via a clutch (30i, 30j) which for each thereof uses a plurality of discs of which a first part is fixed in rotation with a planet gear (6i, 6j) and a second part is fixed in rotation with the case (2) of the differential. The planet gears (6i, 6j) are also mobile in translation along the rotation shaft of their respective output member. According to one preferred embodiment, and in accordance with FIG. 9a1, the device in this embodiment is built so that an axial force of the hub (31j) of a first planet gear (6j) towards the inside of the differential causes the displacement of the assembly formed by the sun gears and planet gears until one edge (32i) of the second planet gear oriented towards the outside of the device comes to bear against the discs of the clutch (30i) which connects this second planet gear (6i) with the case. The second planet gear (6i), by thus applying a pressure on its own clutch, secures in rotation the two planet gears (6i, 6j) with the case (2) of the differential. In the case illustrated in FIG. 9a1, the side referenced i is not subjected to any resisting torque in this situation, it is the more or less full securing of the clutch (30i) which allows the transfer of torque onto the output referenced j. In this situation therefore the dynamic element (34i) is not subjected to any axial force and thus, in the most unfavorable situation for the onset of the positive differential velocity on the side referenced i, its friction torque with the case will be zero. As a result the ramps 33a and 33b are inoperative since they transmit the friction torque of the dynamic element (34i) which is zero in this situation.

Structurally, each of the planet gears (6i, 6j) is associated with its respective output member via a hub (31i 31j). These hubs (31i, 31j) are associated by splines with the output member so as to allow the securing in rotation with their respective member. These hubs (31i, 31j) engage with their respective planet gear (6i, 6j) via mechanical cooperation which firstly allows the driving in rotation of the hub (31i, 31j) by the planet gear (6i, 6j) and secondly allows the drawing away of the hub (31i, 31j) and planet gear (6i, 6j) when the rotation shaft of the output has resisting torque. This cooperative arrangement, as illustrated in FIGS. 9b1 and 9b2, can therefore be formed of a succession of ramps positioned on the periphery of the hub (31i, 31j) to engage with their counterparts arranged on the periphery of the planet gear (6i, 6j). Another arrangement could be formed by ramps belonging to one of the elements, hub or planet gear, and cooperating with at least one intermediate part secured to the other element, planet gear or hub respectively. According to one preferred embodiment, the ramps of the hub (31i) are arranged to have a “V” shape so that the junction of a pair of ramps forms a point oriented in the direction of the planet gear (6i). Therefore one ramp of the hub (31i, 31j) engages with one ramp of the planet gear (6i, 6j) so as to allow either a rotation, or rotation combined with translation.

Each of the hubs (31i, 31j) comprises an edge bearing on the inner face of the case (2) of the differential via a dynamic element (34) and/or a bearing for example, so that the hub forms thrust means for applying an axial force on its corresponding planet gear (6i, 6j) and capable of displacing the assembly formed by the planet gears (6i, 6j) and sun gears of the device. This displacement is performed when there is imbalance between the forces of the thrust means of each output of the differential which occurs when there is torque imbalance at the outputs, this imbalance being caused by a decrease in the axial force of the V-shaped ramps located between the planet gear (6i) and the hub (31i) when loss of resisting torque is ascertained on the side referenced i.

The device according to this fifth embodiment also comprises a mechanism allowing a dynamic thrust to be generated that is antagonistic to the axial forces of the assembly of planet gears (6i, 6j) and hubs (31i, 31j) caused by the thrust means of the output opposite the differential at the time of shifting of the device into differential velocities. According to one preferred embodiment, this device is arranged for each output member and positioned at each planet gear/hub/case assembly using several means (33, 34) provided with ramps and mounted mobile in rotation about the shaft of the corresponding output member. These mobile means are formed in particular of second thrust means (33) which comprise at least one ramp (33a) to interact with at least one ramp of the hub (31) so that sliding of the second thrust means (33) on the hub (31) via their ramps causes displacement of the thrust means (33) towards the inside of the differential. These thrust means also comprise an edge bearing against an outer edge of the planet gear (6) which meshes with the hub (31). Therefore in a situation of differential velocity, the thrust means (33), associated with the elements of the differential in positive velocity relative to the case, generate an axial force against the planet gear (6) with which it is associated. Therefore this force is antagonistic to the axial force generated by the ramps located between the associated planet gear (6) and hub (31) at the opposite output which is in negative velocity relative to the case. According to one particular aspect of embodiment, these thrust means (33) are mounted on the periphery of the hub (31) with which it engages. The ramp or ramps of the hub (31) and of the thrust means (33) are then carried by one or more lugs allowing the opposite-facing positioning of these ramps. These mobile means also comprise an idle-mounted dynamic element (34) mobile in rotation about the rotation axis of the hub (31) and of the thrust means (33). The axial forces of the thrust means are exerted on the dynamic element (34) which produces a friction torque on the case (2) when the device is in differential velocities. This dynamic element (34) comprises at least one ramp (34a) intended to interact with a ramp (33b) of the thrust means (33). The dynamic element (34) then acts on the thrust means (33) via ramps to generate an axial force of the thrust means (33) towards the inside of the differential. The contacts of the dynamic element (34i) and of the hub (31i) on the ramps of the thrust means (33i) cause an axial reaction, for example on the side referenced i, which adds to the axial forces produced by the thrust means formed by the V-shaped ramps located between the planet gear (6i) and the hub (31i) on this same side referenced i. The sum of these axial forces on this side referenced i opposes the forces produced by the thrust means formed by V-shaped ramps located between the planet gear (6j) and the hub (31j) located on the other output of the differential i.e. on the side referenced j. According to one particular embodiment, the ramps of the thrust means (33) form a V either side of which are positioned respective ramps of the hub (31) and of the dynamic element (34). The assembly formed by the hub/thrust means/dynamic element is arranged so that when the output member undergoes a positive differential velocity i.e. when the output member is in “fast velocity” the hub (31) drives in rotation the dynamic element (34) via dynamic thrust means (33), the dynamic element (34) being in friction on the case (2). The thrust means (33) clamped between the hub (31) and the dynamic element (34) then undergoes axial forces at its ramps which are applied onto the planet gear (6). According to one particular embodiment, the dynamic element (34) is arranged on the periphery of the hub (31) with which it engages, between the hub (31) and the thrust means (33). The ramp or ramps of the dynamic element (34) and of the thrust means (33) are then carried by one or more lugs allowing these ramps to be positioned facing one another. To facilitate the rotation between different elements of the differential, bearings can be used in particular between the dynamic element (34) and the hub (31).

According to one preferred embodiment, the thrust means (33) may comprises abutments (33c) for example mounted idle in rotation and arranged to be positioned alternately with the ramps between the lugs which carry the ramps of the dynamic element (34) and of the hub (31).

These abutments come into contact when the output is slow i.e. with negative velocity relative to the case. In the case illustrated, these abutments are parallel to the axis of rotation of the differential but the present invention does not exclude the tilting at an angle of the contact faces of these abutments which could then react as ramps.

If the faces of the abutments are not angled it is also possible for these abutments to be arranged directly between the dynamic element (34) and the hub (31) as illustrated in FIG. 9c2, and the construction is simplified by eliminating the abutment (33c) which is a part mounted idle in rotation about the rotation axis of the hub (31) and independent of the thrust means (33).

The cross-sections 9b1, 9b2, 9c1 and 9c2 respectively show an angular clearance between the abutments and the ramps located between the dynamic element (34), the hub (31) and the dynamic thrust means (33). That is to say that angular rotation will be necessary to move away from the contact on the ramp side due to a positive differential velocity, and to find new contact on the abutments subsequent to a negative differential velocity. This angular clearance is determined on the basis of the desired response time when tuning the differential.

It will be obvious for persons skilled in the art that the present invention allows embodiments in numerous other specific forms without departing from the field of application of the invention such as claimed. The present embodiments are therefore to be construed as illustrations which can be modified in the field defined by the scope of the appended claims.

1. A limited slip differential firstly comprising an input member and two output members and secondly integrating in a case at least one satellite gear and at least one planet gear arranged to allow full or partial securing in rotation of two of the three input and/or output members through the action of at least one first thrust means on securing means when there is a decrease in one of the output torques caused by grip loss or shifting into differential velocities, wherein the differential also comprises at least one second dynamic thrust means antagonistic to the action of the first thrust means, the second antagonistic dynamic thrust means being arranged to be actuated at the time of shifting of the differential into differential velocities.

2. The limited slip differential according to claim 1, wherein the differential comprises an arrangement which is arranged to generate, at the time of shifting of the differential into differential velocities, at least one friction specific to the shifting used to actuate second antagonistic dynamic thrust means.

3. The limited slip differential according to claim 1, wherein the second antagonistic dynamic thrust means form a connection with the output member having differential velocity and with at least one of the other members of the differential via at least one ramp to apply an antagonistic dynamic force generated by friction occurring at the time of shifting of the differential into differential velocities.

4. The limited slip differential according to claim 1 wherein the second antagonistic dynamic thrust means are formed by an element mounted mobile in rotation relative to a planet gear of the differential and/or a hub which connects the planet gear to an output shaft of the differential, the mobile element engaging by means of a ramp in fixed rotation with the planet gear and/or a hub of the differential.

5. The limited slip differential according to claim 4, wherein the second antagonistic dynamic thrust means comprise at least one articulating point bearing against a ramp of a hub of the differential.

6. The limited slip differential according to claim 4, wherein the second antagonistic dynamic thrust means comprise at least one articulating point bearing against a ramp of a planet gear of the differential.

7. The limited slip differential according to claim 4, wherein the second antagonistic dynamic thrust means comprise at least one articulating point bearing against a ramp of an element mounted fixed in rotation with a planet gear and/or a hub of the differential.

8. The limited slip differential according to claim 4, wherein the planet gear is arranged to drive in rotation the hub mounted mobile in translation relative to the planet gear, the hub comprising at least third antagonistic thrust means formed by at least one pair of ramps arranged in a “V” shape so that the junction of the ramps forms a point oriented in the direction of the planet gear to cooperate with the ramps of the planet gear.

9. The limited slip differential according to claim 4, wherein the sun gear is arranged to drive in rotation the planet gear mounted mobile in translation relative to the rotation shaft of the sun gear, the rotation shaft of the sun gear being fixed in rotation with the input member, the planet gear comprising at least one third antagonistic thrust means formed by at least one pair of ramps arranged in a “V” shape so that the junction of the ramps forms a point oriented in the direction of the sun gear to cooperate with the ramps of the sun gear.

10. The limited slip differential according to claim 4, further comprising at least one friction connection able to be placed under pressure by an axial force of the second antagonistic dynamic thrust means under the action of a ramp.

11. The limited slip differential according to claim 4, wherein the second antagonistic dynamic thrust means are mounted formed by an element centered on the axis of rotation of an output of the differential, the second antagonistic dynamic thrust means comprising at least one ramp to combine rotation of the antagonistic dynamic thrust means with axial producing of an antagonistic force at a face bearing against an element of the differential fixed in rotation with the input member.

12. The limited slip differential according to claim 1, wherein the second antagonistic dynamic thrust means are arranged to be driven in rotation at an inner face opposite the rotation shaft of a planet gear, by friction with a planet gear and/or an element mounted fixed in rotation with a planet gear, one end on the periphery of the second thrust means comprising a ramp which is arranged to interact with traction means secured to a pressure ring plate mounted free in translation in the case of the differential so as to generate a dynamic force antagonistic to the displacement of the pressure ring at the time of shifting of the differential into differential velocities.

13. The limited slip differential according to claim 12, wherein the planet gear and/or the element fixed in rotation with the planet gear are mounted mobile in axial translation relative to the shaft of at least one sun gear of the differential, under the action of at least one third antagonistic thrust means formed by ramps.

14. The limited slip differential according to claim 1, the driving in differential rotation of an idle-mounted mobile element by the second antagonistic dynamic thrust means, causes an axial force antagonistic to the force of the thrust means of the opposite output of the differential, the idle-mounted mobile element undergoing a friction torque with an element of the differential when the idle-mounted mobile element is driven in differential rotation.

15. The limited slip differential according to claim 14, the hub and/or the mobile element being configured to engage with the second dynamic thrust means by means of respective ramps.
